(19) United States
(12) Patent Application Publication
(10) Pub. No.: US 2004/0136681 A1
(43) Pub. Date: Jul. 15, 2004

(54) Erbium-doped oxide glass

(75) Inventors: John S. Drewery, Alameda, CA (US); Douglas D. Cannon, Cambridge, MA (US)

Correspondence Address: Thomas Swenson, 1118 13th street, A-5, Boulder, CO, 80302, US

(73) Assignee: Novellus Systems, Inc., San Jose, CA

(21) Appl. No.: 10/339,933

(22) Filed: Jan. 10, 2003

(51) Int. Cl. G02B 6/00; G02B 6/10

(52) U.S. Cl. 385/142; 385/129

(57) ABSTRACT

An optical planar waveguide comprising erbium-doped silica glass has an active core with a length of not less than 5 cm, typically in a range of 0.2 cm to 100 meters, preferably 0.5 cm to 5 meters. Preferably, the active core of the planar waveguide has a serpentine shape. The radius of curvature of the serpentine planar waveguide is in a range of about 0.1 mm to 50 mm, preferably about 20 mm. The erbium-doped silica glass has a low concentration of erbium atoms, corresponding to an Er/Si atomic ratio in a range of 10⁻⁵ to 2×10⁻³, preferably in a range of about from 5×10⁻⁵ to 3×10⁻⁴. A layer of erbium-doped silica glass having a low concentration of erbium is formed on a substrate by sublimating a solid source of an erbium-containing metal organic precursor compound, mixing vaporized molecules of the precursor with other gases for forming silica glass, and: generating a plasma in the reaction mixture.

### FIELD OF THE INVENTION

The invention is related to the field of optical amplifiers, in particular, to erbium-doped planar optical waveguides.

### BACKGROUND OF THE INVENTION

1. Statement of the Problem

In optical communication networks, optical amplifiers are commonly used to restore signal strength in optical signals weakened by propagation losses, splitting and filtering. For example, erbium ions dissolved in silica glass are used to form amplifiers used in dense wavelength division multiplexing, DWDM.

An optical amplifier functions as a result of stimulated emission. Stimulated emission occurs when a photon causes an electron to drop from a higher energy state to a lower energy state simultaneously, or in synchrony. The difference in energy of the two states is exactly equal to the energy of the stimulating photon. Therefore, the emitted photon is also of equal energy. In order to successfully amplify an optical signal, the majority of the electrons must be in the excited state. This condition is called “population inversion”. Typically, a second light source is used to pump the electrons from a normal energy state into a higher energy state. The electrons naturally fall back to the normal energy state, causing spontaneous emission. If the electrons fall back very soon after being raised to the higher energy state, several undesirable effects occur. First, the spontaneous emission will contaminate the optical signal. Second, it will not be possible to obtain a high enough concentration of electrons in the higher energy state (“population inversion”) to produce laser action when a signal pulse comes through. Therefore, the lifetime of the higher energy state of electrons must be relatively long, preferably about 7 microseconds (“μsec”).

The erbium ion, Er³⁺, in low concentrations in certain media, results in emission of light in a band of wavelengths centered at about 1.55 μm. This wavelength corresponds approximately with the highest transparency of silica glass and is used, therefore, to amplify signals in optical communications. Upon illumination by light from a laser or other light source operating near 980 nm wavelength, a population of electrons in Er³⁺-doped silica glass is “pumped” by high-energy photons, resulting in a “population inversion”. When a light pulse sufficiently near in wavelength to 1.55 μm arrives at the population of electrons, stimulated emission occurs and the light pulse is amplified. The amplified light has the same wavelength as the incoming pulse.

An important feature of erbium-doped amplifiers is that each wavelength of the light is separately amplified. An optical wave carrier can carry many signals simultaneously, each signal corresponding to a particular wavelength. If the amplification were to be done electronically, each signal channel would have to be separated, each channel amplified separately, and then all signal channels recombined. Such a process of amplification is complicated and expensive. An advantage of erbium-doped amplifiers is that each signal is amplified simultaneously by one unit.

There are two main types of optical amplifiers: fiber optical amplifiers and planar waveguide optical amplifiers. Fiber amplifiers are optical glass fibers having cores doped with optically active elements, typically rare earth elements such as erbium. They are typically used in medium to long-haul communications when the signal needs to be amplified to restore the signal strength in the optical fiber. About 50 meters of such fiber are needed to create an amplifier. Separate combiners and isolators are used to insert light at a wavelength shorter than that to be amplified (the “pump” beam) and to contain this light within the region of the amplifier. The cost of such devices is considerable, their insertion causes extra power losses, and they are bulky.

A planar waveguide amplifier is a planar waveguide fabricated on a suitable substrate, such as silicon, comprising a silica-glass core doped with optically active elements, such as erbium. An example was described in U.S. Pat. No. 5,563,979 issued Oct. 8, 1996 to Bruce et al. This patent teaches a method of making a waveguide that is much shorter than fiber amplifiers, having a length in a range of about 5 mm to 10 mm. Such planar waveguides are useful for applications in which components need to be relatively small and device integration is desirable, such as premises distribution of optical signals. Because planar waveguide amplifiers typically have a short length, they require a correspondingly higher level of doping with optically active elements to achieve sufficient amplifier gain comparable to fiber amplifiers. Typically, an Er/Si atom ratio of at least 0.01, and preferably 0.03 and greater, is desired. To enhance the solubility of Er³⁺ in silicon oxide glass, modifiers have been added to the doped glass. Erbium atoms cluster when present at high concentrations in glass. Therefore, modifiers also serve to prevent clustering of erbium atoms at high concentrations. Modifiers include lanthanum, alkali metals, such as sodium, and alkaline earth metals, such as calcium. High levels of erbium dopants adversely affect the efficiency of an amplifier. High erbium concentration and clustering of erbium atoms reduce the radiative lifetime of Er³⁺ to below 7 ms, thereby reducing the laser action associated with optical amplifiers. Furthermore, glasses containing significant amounts of such modifiers are not entirely compatible with the silicon substrates on which they are deposited. For example, glasses that contain significant amounts of alkali and alkaline earth metals have a higher coefficient of thermal expansion than the silicon substrate, which can cause stress in the glass films when the glasses are subjected to changes in temperature typically associated with annealing and waveguide fabrication. Also, waveguides with alkali and alkaline earth metals cannot tolerate temperatures greater than about 900° C. Also, out-diffusion of mobile alkali metals adversely affects the homogeneity of the glass films and increases the defect density of the film. Furthermore, alkali and alkaline earth metals are detrimental to some other processes for making silicon-based devices (e.g., integrated circuits), so equipment used to form glasses containing these modifiers cannot be used for processing other silicon-based devices.

U.S. Pat. No. 5,119,460 issued Jun. 2, 1992 to Bruce et al. teaches a planar optical waveguide structure comprising an erbium-doped active core of silica glass having a typical total length of 5 mm or more and containing an effective amount of sodium to enhance erbium-solubility. The active-core glass has a sodium-to-silicon atomic ratio, Na/Si, of about from 0.2 to 0.6. This patent also teaches including a quantity of calcium, up to a calcium-to-silicon atomic ratio of about 0.2, to enhance erbium solubility and to stabilize the glass. The Er-doped films were formed by sputter deposition. The active core has a relatively high concentration of erbium. The erbium-to-silicon atomic ratio is at least 0.01, preferably at least 0.02, and still more preferably about 0.03. The absolute erbium concentration is at least about 1.4×10²⁰ atoms/cm³. The patent also teaches that a smaller erbium-to-silicon ratio is undesirable because it could lead to an undesirably small value of signal gain per unit length of the amplifier.

U.S. Pat. No. 5,563,979 issued Oct. 8, 1996 to Bruce et al. teaches a planar optical waveguide structure comprising an active core having a typical total length of 5 mm or more and containing erbium and modifier material that is not an alkali metal or an alkaline earth metal. The Er-doped films were formed by sputter deposition. The modifier material has at least two components. One component, such as lanthanum oxide, enhances the solubility of erbium ions in silicon oxide. As a result, the active core has a relatively high concentration of erbium. The erbium-to-silicon atomic ratio is at least 0.005, more preferably at least 0.02. The absolute erbium concentration is at least about 0.5×10²⁰ atoms/cm³. The high erbium concentration is necessary to provide a satisfactory value of signal gain per unit length of the amplifier. A second component of the modifier, such as aluminum oxide or gallium oxide, stabilizes the glass composition. While such a structure reduces some of the adverse effects of alkali and alkaline earth metals in an active core, the high concentration of erbium ions reduces the efficiency of the amplifier.

Fabrication of an erbium-doped planar waveguide requires introduction of erbium ion, Er³⁺, into an optical glass, such as silicon dioxide, forming an active core comprising erbium oxide, Er₂O₃. Various techniques for doing this have been studied. U.S. Pat. No. 5,119,460 and U.S. Pat. No. 5,563,979 referenced above teach sputtering of a target containing silicon and erbium to form an erbium-doped active core. Tsybeskov et al. used a process in which wet-etched porous silicon was impregnated in erbium nitrate/ethanol solution. Appl. Phys. Lett., 70 (14), pp. 1790-1792 (1997). Mishakov inserted evaporators into a vacuum chamber and evaporated a metalorganic material into a process space in which thermal CVD was conducted to deposit the silicon. Proc. SPIE, 3688, pp. 374-381 (1999). Shin et al. used co-sputtering in conjunction with ECR-assisted CVD. Appl. Phys. Lett., 73 (25), pp. 3647-3649 (1998). None of these techniques is practical for making an erbium-doped active core having a relatively low concentration of erbium. Wet impregnation is incompatible with many prior and subsequent processing steps of amplifier fabrication. The technique of Mishakov is relatively slow, with a maximum deposition rate of about 55 nm per minute, and the apparatus is suited only for forming the active core, making the effective capital cost of the equipment high. The ECR technique of Shin et al. is not a practical CVD method because of its relatively poor deposition uniformity and its high cost.

### SUMMARY OF THE INVENTION

The invention helps to solve some of the problems mentioned above by providing an efficient, thermally stable, planar waveguide amplifier having good gain characteristics that is compatible with integrated circuit fabrication equipment.

In one aspect, an erbium-doped planar optical waveguide in accordance with the invention comprises a waveguide core comprising, erbium-doped silica glass, and the waveguide core has a length of not less than 5 cm. Typically, an erbium-doped planar optical waveguide core has a length in a range of about from 5 cm to 100 meters, more typically in a range of about from 0.2 meters to 50 meters. Preferably, an erbium-doped planar optical waveguide core in accordance with the invention has a length in a range of about from 0.5 meters to 5 meters.

In another aspect, an erbium-doped planar optical waveguide in accordance with the invention comprises silica glass containing erbium atoms in a concentration corresponding to an erbium-to-silicon atomic ratio not exceeding 0.002. Typically, the silica glass contains erbium atoms in a concentration corresponding to an erbium-to-silicon atomic ratio in a range of about from 10⁻⁵ to 2×10⁻³. Preferably, the silica glass contains erbium atoms in a concentration corresponding to an erbium-to-silicon atomic ratio in a range of about from 5×10⁻⁵ to 3×10⁻⁴. In another aspect, the silica glass contains erbium atoms in a concentration not exceeding 5×10¹⁹ erbium-atoms per cubic centimeter. Typically, the silica glass contains erbium atoms at a concentration in a range of about from 2.3×10¹⁷ Er-atoms per cm³ to 4.6×10¹⁹ Er-atoms per cm³. Preferably, the silica glass contains erbium atoms at a concentration in a range of about from 1.15×10¹⁸ to 6.9×10¹⁸ Er-atoms per cm³.

In another aspect, a waveguide core in accordance with the invention is configured in a serpentine shape. Generally, the serpentine shape has a radius of curvature not less than 0.1 mm. Typically, the serpentine shape has a radius of curvature not less than 5 mm. Preferably, the serpentine shape has a radius of curvature in a range of about from 5 mm to 60 mm.

In another aspect, in an erbium-doped planar optical waveguide in accordance with the invention, the waveguide core has a length greater than 20 cm and the waveguide core is disposed within a surface area of substrate not exceeding 100 cm².

In another aspect, a method in accordance with the invention for fabricating erbium-doped oxide glass on a substrate comprises flowing gaseous organic erbium-containing precursor molecules into a PECVD reaction chamber, flowing gaseous molecules comprising oxidizable nonmetallic glass-forming atoms into the PECVD reaction chamber, flowing gaseous oxidizer molecules into the PECVD reaction chamber, and forming a plasma in the PECVD reaction chamber. In another aspect, a method in accordance with the invention further comprises sublimating a solid source of an organic erbium-containing precursor compound to form the gaseous organic erbium-containing precursor molecules. In another aspect, sublimating a solid source is conducted in a sublimation cell at a temperature not exceeding 200° C. In still another aspect, sublimating a solid source comprises sublimating a solid source selected from the group consisting of erbium tris(bis(trimethylsilyl)amide); erbium tris(6,6,7,7,8,8,8-heptafluoro-2,2-dimethyl-3,5-octanedioate); and erbium tris(2,2,6,6-tetramethyl-3,5-heptanedioate). In still another aspect, a method in accordance with the invention further comprises flowing an inert carrier gas through the sublimation cell.

In another aspect, a method in accordance with the invention further comprises maintaining a pressure in the PECVD reaction chamber in a range of about from 1 Torr to 10 Torr. In still another aspect, a method further comprises heating the substrate at a temperature in a range of about from 250° C. to 800° C.

In still another aspect, forming a plasma comprises applying high-frequency radio-frequency power to the reaction chamber. Generally, applying high-frequency radio-frequency power comprises applying power having a frequency in a range of about from 1 MHz to 100 MHz. In another aspect, forming a plasma comprises applying high-frequency power in a range of about from 0.05 Watts per cm² to 3.2 Watts per cm² of the substrate.

In another aspect, forming a plasma comprises applying low-frequency radio-frequency power to the reaction chamber, generally with a frequency in a range of about from 100 kHz to 1 MHz.

### BRIEF DESCRIPTION OF THE DRAWINGS

A more complete understanding of the invention may be obtained by reference to the drawings, in which:

FIG. 1 depicts in schematic form a top view 100 of an exemplary erbium-doped planar optical waveguide in accordance with the invention;

FIG. 2 depicts in schematic form a section of the planar optical waveguide of FIG. 1;

FIG. 3 depicts in schematic form a PECVD apparatus for depositing a layer of erbium-doped silica glass using a method in accordance with the invention;

FIG. 4 depicts in schematic form a section of the substrate of FIG. 2 in an earlier stage of fabrication and comprising a lower cladding layer;

FIG. 5 depicts in schematic form a section of the substrate of FIG. 4 on which a layer of erbium-doped silica glass in accordance with the invention has been deposited on the lower cladding layer; and

FIG. 6 depicts in schematic form a section of the substrate of FIG. 5 from which portions of the layer of erbium-doped silica glass were removed to form a serpentine-shaped active core in accordance with the invention.

### DESCRIPTION OF THE INVENTION

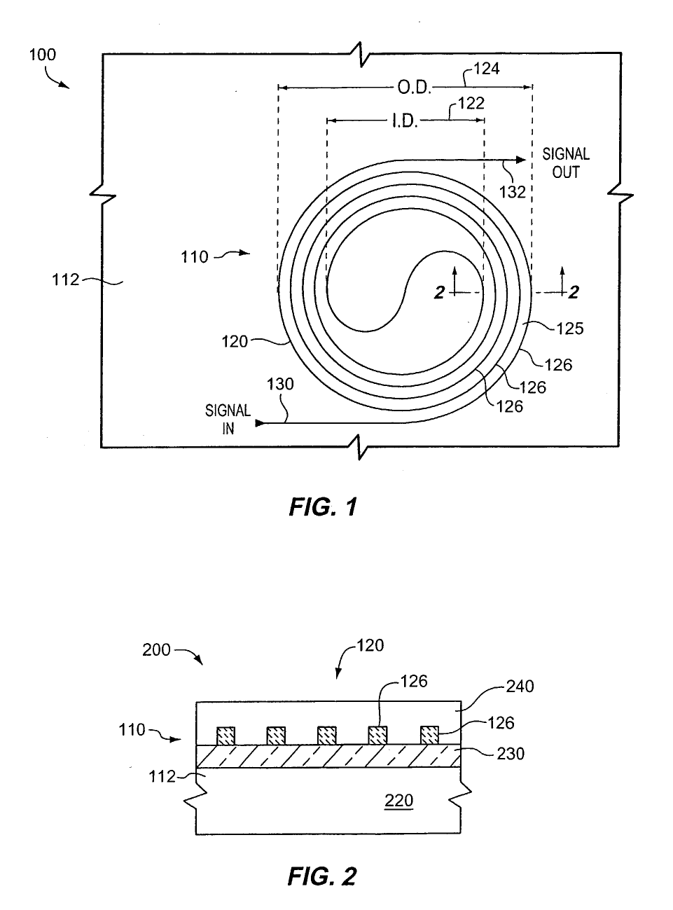

The invention is described herein with reference to FIGS. 1-6. It should be understood that the structures and systems depicted in schematic form in FIGS. 1-6 serve explanatory purposes and are not precise depictions of actual structures and systems in accordance with the invention. Furthermore, the embodiments described herein are exemplary and are not intended to limit the scope of the invention, which is defined in the claims below.

FIG. 1 depicts in schematic form a top view 100 of an exemplary erbium-doped planar optical waveguide 110 in accordance with the invention. Optical planar waveguide 110, disposed on silicon semiconductor substrate 112, has a serpentine shape in accordance with the invention. The term “serpentine” in this specification refers generally to any non-intersecting curved path. Generally, a serpentine structure in this specification has a length greater than 5 cm that lies within an area of substrate not exceeding about 100 cm² and has a radius of curvature not less than 0.1 mm. It is understood, therefore, that an elongated serpentine waveguide in accordance with the invention is not limited to any particular spiral shape, but rather has any curved shape having a minimal radius of curvature of about 0.1 mm. A waveguide 110 in accordance with the invention has a total length up to about 100 meters or longer, typically not less than 20 cm, preferably in a range of about from 0.5 m to 5 m. The relatively long length allows a relatively low erbium concentration to provide sufficient amplifier gain. The relatively low erbium concentration improves amplifier efficiency; that is, it enhances radiative lifetime and reduces losses per unit length of waveguide. In a typical embodiment in accordance with the invention, a serpentine-shaped planar waveguide 110 comprises an active waveguide core 120 having a total length of about two meters and a radius of curvature of about 20 mm. With reference to FIG. 1, the inside diameter (“ID”) 122 of the wound core is about 40 mm, the spacing 125 between adjacent winds 126 of core 120 is about 20 μm, and the outside diameter 124 (“OD”) is about 45 mm. The active core preferably has a vertical thickness in a range of about 1 μm to 5 μm, preferably between 1 μm and 2 μm. The width of the erbium-doped active silica core 120 is preferably in a range of about 2 μm to 8 μm. A waveguide core having a length of approximately two meters is typically formed on a piece of wafer having an area of about 25 cm². These dimensions correspond to waveguides in which the cladding has a refractive index of about 1% or less lower than the refractive index of the core. Smaller waveguide dimensions are obtained as a result of larger differences between the refractive indices. Larger contrasts between the refractive indices of the core and the cladding, however, lead in general to greater losses of light from the core. One skilled in the art balances these considerations along with others to arrive at optimal index contrast and core dimensions. The serpentine shape is manufactured using standard lithographic techniques, typically with a mask aligner. An optical dovetail (not shown), typically a fiber optical dovetail, is attached at each end 130, 132 of the serpentine core.

FIG. 2 depicts in schematic form a section 200 of planar optical waveguide 110 taken through lines 2-2 of FIG. 1. Substrate 112 comprises silicon semiconductor substrate 220. A lower cladding layer 230 comprising silicon dioxide is disposed on silicon semiconductor material 220. Winds 126 of active core 120 are disposed in a winding, serpentine shape on lower cladding layer 230. Upper cladding layer 240, comprising silicon dioxide, is disposed on active core 120 and lower cladding layer 230, thereby covering winds 126 of active core 120.

In this specification, the term “substrate” and related terms are used to refer to the underlying semiconductor material 220 on which the planar waveguide is formed, as well as any object on which a thin film layer is deposited. In this disclosure, “substrate” generally means the entire workpiece as it exists at a particular phase of fabrication and on which a particular fabrication process is being conducted.

The long dimension of substrate 122 and semiconductor material 220 as depicted in FIG. 2 defines planes that are considered to be “horizontal”, and directions perpendicular up and down to this plane are considered to be “vertical”. Terms of orientation herein, such as “above”, “top”, “upper”, “below”, “bottom”, and “lower”, mean relative to semiconductor material 220. That is, if a second element is “above” a first element, it means it is farther from semiconductor material 220; and if it is “below” another element, then it is closer to semiconductor material 204 than the other element. Terms such as “above” and “below” do not, by themselves, signify direct contact. However, terms such as “on” or “onto” do signify direct contact of at least a portion of one layer with at least a portion of an underlying or adjacent layer.

The term “silica glass” has its usual meaning of an oxide glass substantially comprising silicon dioxide, but also optionally comprising other compounds in smaller amounts. With reference to concentration, the terms “erbium atoms”, “erbium ions”, “Er” and “Er³⁺” are used synonymously in this specification.

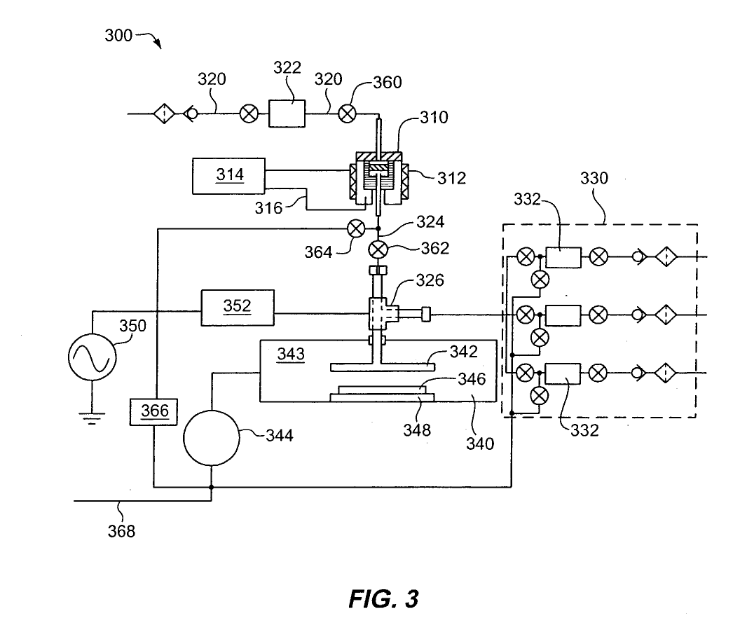

FIG. 3 depicts in schematic form a PECVD apparatus 300 for depositing a layer of erbium-doped silica glass using a method in accordance with the invention. The process operating parameters discussed with reference to FIG. 3 have been normalized for a single process station of a Novellus model “Sequel” PECVD apparatus treating a 200 mm wafer. Apparatus 300 comprises a sublimation cell 310 in which a solid source comprising a metalorganic erbium-containing precursor compound in accordance with the invention is disposed. Preferably, the erbium source compound has a sublimation temperature below 200° C. and does not decompose below about 300° C. Examples of erbium-containing precursor compounds in accordance with the invention include, but are not limited to: erbium tris(bis(trimethylsilyl)amide); erbium tris(6,6,7,7,8,8,8-heptafluoro-2,2-dimethyl-3,5-octanedioate) (“erbium fod”); and erbium tris(2,2,6,6-tetramethyl-3,5-heptanedioate).

The temperature in sublimation cell 310 is held at a fixed temperature, typically in a range of about from 100° C. to 200° C., preferably 150° C. to 190° C., by heater 312, which is controlled by a closed-loop temperature controller 314. A sensor, such as thermocouple 316, functions as a temperature feedback element. An inert carrier gas, such as argon, flows through carrier gas tube 320 and carrier-gas mass-flow controller 322 into sublimation cell 310 and entrains sublimated vapor of the erbium-containing precursor compound. The carrier gas typically has a flowrate in a range of about from 20 sccm to 1000 sccm, preferably about 200 sccm. Carrier gas and entrained precursor vapor flow from sublimation cell 310 through precursor gas tube 324 into gas mixer 326. Other reaction gases flow through gas manifold 330 into gas mixer 326. Mass flow controllers 332 control the flowrates of gases through manifold 330 into gas mixer 326. Generally, reaction gases include a silicon-containing compound for forming silica glass, for example, silane, SiH₄, or other precursor known in the art. An exemplary flowrate of silane is in a range of about from 10 sccm to 150 sccm, preferably about 50 sccm. Usually, an oxidizing gas, such as nitrous oxide, N₂O, or oxygen gas, O₂, is supplied through manifold 330 to gas mixer 326. When the oxidizing gas is N₂O, then its flowrate is in a range of about from 500 sccm to 4500 sccm, preferably about 1500 sccm. When the oxidizing gas is O₂, its flowrate is generally less than N₂O. Optionally, N₂-gas is supplied to gas mixer 326 at a flowrate in a range of from 0 sccm to 500 sccm. N₂-gas is useful for decreasing the oxidizing power of the oxidizing gas in a reaction chamber, while maintaining a volumetric gas flowrate out of gas mixer 326 sufficient for good uniformity of film thickness and other properties of the erbium-doped silica glass. The resulting gas mixture comprising erbium-containing precursor molecules, carrier gas, and the oxidizing gas and any other gases supplied by manifold 330 flows from gas mixer 326 into reaction chamber 340 through showerhead 342. Reaction chamber interior 343 is capable of being evacuated to below one mTorr by pumping system 344. PECVD deposition of erbium-doped silica glass in accordance with the invention is generally conducted at a pressure in a range of about from 1 Torr to 10 Torr, preferably about 2.5 Torr.

A substrate 346 is disposed on substrate holder 348. Typically, substrates holder 348 comprises a substrate heater for heating substrate 346 to a desired temperature, typically in a range of about from 250° C. to 800° C., preferably at 400° C. Showerhead 342 is heated directly by a heater (not shown), or by conduction, convection, and radiation from heated substrate holder 348. Plasma discharge in reaction chamber 340 is sustained by energy applied to reaction chamber 340 by a high-frequency radio-frequency (“HF RF”) generator 350 through network 352. Typically, the HF RF plasma energy used is 13.56 MHz, although the invention is not limited to any exact frequency value. Generally, the HF RF has a frequency in a range of about from 1 MHz to 100 MHz, preferably 2 MHz to 30 MHz. HF RF power is generally applied on showerhead 326 at a level in a range of about 20 Watts to 1000 Watts, corresponding to a range of about 0.05 Watts per cm² to 3.2 Watts per cm² of substrate surface. The reactive species formed in the plasma react to form erbium-doped silica glass on the substrate surface. The erbium-doped silica glass thus formed in accordance with the invention has an atomic concentration of erbium ions corresponding to an atomic ratio of erbium-to-silicon atoms, Er/Si, in a range of about from 10⁻⁵ to 2×10⁻³, preferably in a range of about from 5×10⁻⁵ to 3×10⁻⁴. These concentration ranges correspond approximately to 2.3×10¹⁷ Er-atoms per cm³ to 4.6×10¹⁹ Er-atoms per cm³, preferably a range of about from 1.15×10¹⁸ to 6.9×10¹⁸ Er-atoms per cm³.

In an alternative embodiment of a method in accordance with the invention, a dual-frequency chamber also provides low-frequency radio-frequency (“LF RF”) power to the plasma. With respect to applying HF and LF power, the term “to the reaction chamber” is used here in a broad sense. For example, HF RF generator 350 supplies power to the reactant gas mixture flowing from gas mixer 326 into showerhead 342, as depicted in FIG. 3, or alternatively, it supplies power in showerhead 342 or in reaction chamber interior 343.

Similarly, with respect to introducing or flowing gases and gaseous molecules “to the reaction chamber”, the term “to the reaction chamber” and related terms are used broadly to mean towards and up to the reaction chamber or into the reaction chamber depending on where plasma-forming power is applied in a particular CVD apparatus used in accordance with the invention. For example, in certain embodiments in accordance with the invention, plasma-initiating power is applied to a gaseous stream prior to its entry into the reaction chamber, so that molecules originally present in the gaseous stream are already broken up into reactive components upon actual entry into the reaction chamber.

Valves 360, 362 allow for isolation of sublimation cell 310. Valve 364 allows diversion of the gaseous dopant precursor stream to a cold trap 366, in which the erbium-containing precursor compound is condensed before the carrier gas passes to vacuum line 368.

Gas flow tubing and fittings between sublimation cell 310 and showerhead 342 are heated to an appropriate temperature to avoid condensation. This is achieved by providing heaters (not shown), which are controlled open-loop or close-loop from a suitable power supply. Preferably, the gas delivery system comprising gas flow tubing, valves, and fittings is designed to enhance laminar flow, because laminar flow reduces the impingement of precursor on the walls of the delivery system.

Use of the carrier gas allows erbium-containing precursor compounds with low vapor pressure to be transported to reaction chamber 340, which is at a higher pressure than the vapor pressure of the erbium-containing reactant precursor. The design of sublimation cell 310 provides sufficient exposed surface area of solid precursor source so that the flowrate of erbium-containing precursor compound, or other sublimating dopant or additive, is determined by the precursor vapor pressure and not by the sublimation rate. If this were not done, the precursor vapor would be swept away by carrier gas faster than sublimation occurred, and the partial pressure of sublimating precursor entering the reaction chamber would decrease. The design of sublimation cells and solid sources is known in the art.

In certain applications, it is desirable to introduce aluminum as a dopant in addition to other materials. This may be done using a number of solid-source precursors. For example, aluminum tris(2,2,6,6-tetramethyl 3,5-heptanedionate) sublimes at 75° C., and is supplied through a solid-to-gas delivery system similar to that of the erbium-containing precursor.

Process operating conditions are selected to minimize incorporation of carbon into the silica glass of an active core. Operating conditions are also selected to achieve desired stoichiometry of the erbium-doped silica glass in the active core. For example, a silicon-rich composition of silicon oxide in erbium-doped silica glass is represented by the stoichiometric formula SiₓO₂, in which x has a value in a range of about from 1.0 to 1.38. A silicon-rich compositions is used to create silicon nanocrystals in the oxide upon subsequent annealing. Silicon nanocrystals enhance erbium photoluminescence.

An advantage of a PECVD method in accordance with the invention is that formation of erbium-doped 'silica glass having a low concentration of erbium can be conducted using a conventional PECVD apparatus. Furthermore, deposition of erbium-doped silica glass can be conducted using the same equipment utilized for other processes of planar waveguide fabrication, for example, for deposition of silicon-oxide lower cladding layers and upper cladding layers.

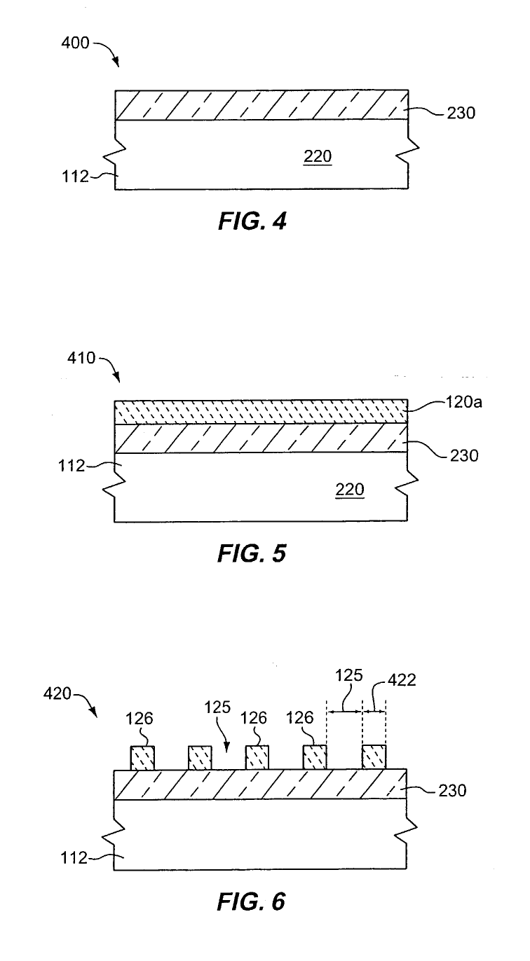

FIG. 4 depicts in schematic form a section 400 of substrate 112 of FIG. 2 in an earlier stage of fabrication. Substrate 220 typically comprises silicon semiconductor material. Silicon-dioxide lower cladding layer 230 typically is formed by long-term thermal anneal, as known in the art, for example, by long-term oxidation in water vapor. In certain embodiments, substrate 220 comprises a plurality of device layers, and lower cladding layer 230 is formed, for example, on a dielectric layer or a passivation layer. In such circumstances, lower cladding layer 230 is formed using thermal CVD or PECVD, as known in the art. The thickness of lower cladding layer 230 is typically in a range of about from 10 μm to 20 μm.

FIG. 5 depicts a section 410 of substrate 112 on which a layer of erbium-doped silica glass 120a in accordance with the invention has been deposited on lower cladding layer 230. Preferably, active-core layer 120a is deposited using a PECVD technique in accordance with the invention. In certain embodiments, the active core layer contains an additive to change its refractive index, making it higher than the lower cladding layer. Preferably, active-core layer 120a is deposited to have a thickness in a range of about 1 μm to 5 μm, preferably about 1.5 μm, determined by the need to keep the final waveguide single mode. A mode is an electric field pattern. Thick waveguides can propagate in several modes, which is undesirable because the modes propagate at different speeds, causing the signal to spread out.

FIG. 6 depicts a section 420 in which portions of active-core layer 120a were removed to form serpentine-shaped active core 120 of erbium-doped planar optical waveguide 110 (see FIG. 1). The individual windings 126 of active core 120 typically have a width 422 in a range of about 2 μm to 8 μm. The spacings 125 between adjacent winds 126 of active core 120 are typically in a range of about from 10 μm to 40 μm, preferably about 20 μm. Standard techniques known in the art are used to pattern and etch active core layer 120a (see FIG. 5) to form serpentine-shaped active core 120. Thereafter, with techniques known in the art, silicon-dioxide upper cladding layer 240 is deposited on substrate 112, as depicted in FIG. 2. The upper cladding layer is also in a range of about from 10 μm to 20 μm. As known in the art, the refractive index of active core 120 is greater than the refractive index of both cladding layers 230, 240.

A principal difference between the prior art and the present invention is that the prior art commonly uses flame hydrolysis deposition, and the present invention uses PECVD. Nevertheless, a flame hydrolysis deposition technique or other technique known in the art can be used to deposit an active core having a long, serpentine shape in accordance with the invention.

A relatively low concentration of erbium in accordance with the present invention reduces or eliminates the need to add lanthanum (for increased erbium solubility), sodium (to reduce erbium clustering), and other additives. If additives are to be included in the active core layer, the additive precursors preferably are from gaseous sources, rather than from sublimating solid sources, which are relatively difficult to manage.

### EXAMPLE 1

A layer of erbium-doped silica glass is formed in accordance with the invention onto a silicon-oxide cladding layer of a 200-mm silicon semiconductor wafer substrate using the following preferred process operating conditions.

A solid source of erbium tris(bis(trimethylsilyl)amide) precursor is sublimated in a sublimation cell at a temperature of 160° C. Argon carrier gas is flowed through the sublimation cell at a flowrate of 200 sccm and entrains the vaporized precursor, which it carries to a gas mixer. Gaseous silane, SiH₄, having a flowrate of 50 sccm, nitrous oxide, N₂O, having a flowrate of 1500 sccm, and N₂-gas, having a flowrate of 250 sccm, are also flowed into the gas mixer. The resulting reaction mixture flows through a showerhead into a PECVD reaction chamber of a Novellus model “Sequel” apparatus. The flow path between sublimation cell and reaction chamber is heated in such a way that the temperature gradually increases between the cell and the chamber, the showerhead being at a temperature below that at which significant precursor decomposition occurs. HF-RF voltage having a frequency of 13.56 MHz is applied at power of 220 watts to the showerhead to generate a plasma in the reaction gas mixture. The reaction chamber is maintained at a pressure of 2.4 Torr. A substrate heater heats the substrate at a temperature of 400° C. The resulting layer of erbium-doped silica glass forms on the substrate and has a thickness of 1.5 μm.

### EXAMPLE 2

A silicon-rich layer of erbium-doped silica glass is formed in accordance with the invention on a silicon oxide cladding layer of a semiconductor wafer substrate using the process operating conditions described in Example 1, except that the flow of silane is 60 sccm, the flow of N₂O is 1000 sccm, and the flow of N₂-gas is 466 sccm. In addition, the pressure of the reaction chamber is maintained at 2.55 Torr.

The low concentration of erbium atoms in erbium-doped silica glass and planar optical waveguide amplifiers in accordance with the invention enhances mechanisms of photoluminescence and laser action, in particular, because the low concentration of erbium atoms allows a long radiative lifetime of the excited electrons associated with the erbium ions. Erbium-doped silica glass and a planar optical waveguide amplifier in accordance with the invention emit light in a relatively narrow emission band, typically not exceeding 0.5 nm, with a wavelength of about 1.55 μm, and they amplify a light signal carrying many streams of information at different wavelengths within the emission band. Pump radiation to generate a population inversion of electrons in the erbium-doped silica glass is effective at any of a group of wavelengths, including 980 nm, 810 nm, 660 nm, 514 nm, and 1.48 μm. It is understood that erbium-doped silica glass and an active core of a planar waveguide in accordance with the invention are electrically nonconductive.

Compositions of erbium-doped silica glass, structures of optical planar waveguide amplifiers, and methods and precursors for forming them in accordance with the invention are useful in a wide variety of circumstances and applications. It is evident that those skilled in the art may now make numerous uses and modifications of the specific embodiments described, without departing from the inventive concepts. It is also evident that the steps recited may, in some instances, be performed in a different order; or equivalent structures and processes may be substituted for the structures and processes described. Since certain changes may be made in the above systems and methods without departing from the scope of the invention, it is intended that all subject matter contained in the above description or shown in the accompanying drawings be interpreted as illustrative and not in a limiting sense. For example, in the art, devices are known that comprise other layers besides a lower and an upper cladding layer proximate to the active core of a planar waveguide. These additional layers, known, for example, as passive cores and cover films, among others, are generally used to improve the wave-guiding characteristics of the active core. Thus, it is understood that structures, methods, and compositions in accordance with the invention are useful in embodiments of planar waveguides and their fabrication that differ from the particular embodiments described herein. Consequently, the invention is to be construed as embracing each and every novel feature and novel combination of features present in or inherently possessed by the systems, methods, and compositions described in the claims below and by their equivalents.

We claim:

1. An erbium-doped planar optical waveguide, comprising a waveguide core, said waveguide core comprising erbium-doped silica glass, said waveguide core having a length not less than 5 cm.

2. An erbium-doped planar optical waveguide as in claim 1 wherein said waveguide core has a length in a range of about from 5 cm to 100 meters.

3. An erbium-doped planar optical waveguide as in claim 2 wherein said waveguide core has a length in a range of about from 0.2 meters to 50 meters.

4. An erbium-doped planar optical waveguide as in claim 2 wherein said waveguide core has a length in a range of about from 0.5 meters to 100 meters.

5. An erbium-doped planar optical waveguide as in claim 4 wherein said waveguide core has a length in a range of about from 0.5 meters to 5 meters.

6. An erbium-doped planar optical waveguide as in claim, 1 wherein said silica glass contains erbium atoms in a concentration corresponding to an erbium-to-silicon atomic ratio not exceeding 0.002.

7. An erbium-doped planar optical waveguide as in claim 6 wherein said silica glass contains erbium atoms in a concentration corresponding to an erbium-to-silicon atomic ratio in a range of about from 10⁻⁵ to 2×10⁻³.

8. An erbium-doped planar optical waveguide as in claim 7 wherein said silica glass contains erbium atoms in a concentration corresponding to an erbium-to-silicon atomic ratio in a range of about from 5×10⁻⁵ to 3×10⁻⁴.

9. An erbium-doped planar optical waveguide as in claim 1 wherein said silica glass contains erbium atoms in a concentration not exceeding 5×10¹⁹ erbium-atoms per cubic centimeter.

10. An erbium-doped planar optical waveguide as in claim 9 wherein said silica glass contains erbium atoms at a concentration in a range of about from 2.3×10¹⁷ Er-atoms per cm³ to 4.6×10¹⁹ Er-atoms per cm³.

11. An erbium-doped planar optical waveguide as in claim 10 wherein said silica glass contains erbium atoms at a concentration in a range of about from 1.15×10¹⁸ Er-atoms per cm³ to 6.9×10¹⁸ Er-atoms per cm³.

12. An erbium-doped planar optical waveguide as in claim 1 wherein said waveguide core is configured in a serpentine shape.

13. An erbium-doped planar optical waveguide as in claim 12 wherein said serpentine shape has a radius of curvature not less than 0.1 mm.

14. An erbium-doped planar optical waveguide as in claim 13 wherein said serpentine shape has a radius of curvature not less than 5 mm.

15. An erbium-doped planar optical waveguide as in claim 14 wherein said serpentine shape has a radius of curvature in a range of about from 5 mm to 60 mm.

16. An erbium-doped planar optical waveguide as in claim 12 wherein said waveguide core has a length greater than 20 cm and said waveguide core is disposed within a surface area of substrate not exceeding 100 cm².

17. A method for fabricating erbium-doped oxide glass on a substrate, comprising steps of:
flowing gaseous organic erbium-containing precursor molecules into a PECVD reaction chamber;
flowing gaseous molecules comprising oxidizable nonmetallic glass-forming atoms into said PECVD reaction chamber;
flowing gaseous oxidizer molecules into said PECVD reaction chamber; and
forming a plasma in said PECVD reaction chamber.

18. A method as in claim 17, further comprising sublimating a solid source of an organic erbium-containing precursor compound to form said gaseous organic erbium-containing precursor molecules.

19. A method as in claim 18, further characterized in that said sublimating is conducted in a sublimation cell at a temperature not exceeding 200° C.

20. A method as in claim 18, further characterized in that said sublimating a solid source comprises sublimating a solid source selected from the group consisting of erbium tris(bis(trimethylsilyl)amide); erbium tris(6,6,7,7,8,8,8-heptafluoro-2,2-dimethyl-3,5-octanedioate); and erbium tris(2,2,6,6-tetramethyl-3,5-heptanedioate).

21. A method as in claim 18, further comprising flowing an inert carrier gas through a sublimation cell.

22. A method as in claim 17, further comprising maintaining a pressure in said PECVD reaction chamber in a range of about from 1 Torr to 10 Torr.

23. A method as in claim 17, further comprising heating said substrate at a temperature in a range of about from 250° C. to 800° C.

24. A method as in claim 17, further characterized in that said forming a plasma comprises applying high-frequency radio-frequency power to said reaction chamber.

25. A method as in claim 24, further characterized in that said applying high-frequency radio-frequency power comprises applying power having a frequency in a range of about from 1 MHz to 100 MHz.

26. A method as in claim 25, further characterized in that said applying high-frequency radio-frequency power comprises applying power in a range of about from 0.05 Watts per cm² to 3.2 Watts per cm² of said substrate.

27. A method as in claim 17 wherein said forming a plasma comprises applying low-frequency radio-frequency power to said reaction chamber.

28. A method as in claim 27 wherein said applying low-frequency radio-frequency power comprises applying low-frequency radio-frequency power having a frequency in a range of about from 100 kHz to 1 MHz.

29. An erbium-doped oxide glass fabricated in accordance with the method of claim 17.

30. An erbium-doped planar optical waveguide, comprising a waveguide core comprising erbium-doped silica glass, wherein said silica glass contains erbium atoms in a concentration corresponding to an erbium-to-silicon atomic ratio not exceeding 0.002.

31. An erbium-doped planar optical waveguide as in claim 30 wherein said silica glass contains erbium atoms in a concentration corresponding to an erbium-to-silicon atomic ratio in a range of about from 10⁻⁵ to 2×10⁻³.

32. An erbium-doped planar optical waveguide as in claim 31 wherein said silica glass contains erbium atoms in a concentration corresponding to an erbium-to-silicon atomic ratio in a range of about from 5×10⁻⁵ to 3×10⁻⁴.

33. An erbium-doped planar optical waveguide as in claim 30 wherein said silica glass contains erbium atoms in a concentration not exceeding 5×10¹⁹ erbium-atoms per cubic centimeter.

34. An erbium-doped planar optical waveguide as in claim 33 wherein said silica glass contains erbium atoms at a concentration in a range of about from 2.3×10¹⁷ Er-atoms per cm³ to 4.6×10¹⁹ Er-atoms per cm³.

35. An erbium-doped planar optical waveguide as in claim 34 wherein said silica glass contains erbium atoms at a concentration in a range of about from 1.15×10¹⁸ Er-atoms per cm³ to 6.9×10¹⁸ Er-atoms per cm³.
